(19) United States
(12) Patent Application Publication
(10) Pub. No.: US 2025/0141065 A1
(43) Pub. Date: May 1, 2025

(54) BATTERY AND MODULE

(71) Applicant: TOYOTA JIDOSHA KABUSHIKI KAISHA, Toyota-shi (JP)

(72) Inventors: Hajime HASEGAWA, Aichi-ken (JP); Mitsuru TATEISHI, Toyota-shi (JP); Norihiro OSE, Nagoya-shi (JP); Masashi CHIHARA, Nagoya-shi (JP); Kota OHATA, Toyota-shi (JP); Masahiro ISHIZUKA, Toyota-shi (JP)

(21) Appl. No.: 18/824,922

(22) Filed: Sep. 5, 2024

(30) Foreign Application Priority Data
Nov. 1, 2023 (JP) 2023-187954

(51) Int. Cl. H01M 50/54; H01M 50/536

(52) U.S. Cl. CPC H01M 50/54; H01M 50/536

(57) ABSTRACT

A battery includes a layer-type electrode body, a laminate exterior body, a positive electrode tab, and a negative electrode tab. In the electrode body, a positive electrode sheet and a negative electrode sheet are alternately layered in a layering direction via a separator sheet. The positive electrode tab protrudes from the laminate exterior body toward one side in a first direction orthogonal to the layering direction. The negative electrode tab protrudes from the laminate exterior body toward the one or another side in the first direction. The electrode body has an overlap region in which only plural separator sheets overlap at both edge regions in a second direction orthogonal to the layering direction and to the first direction. At least one of the two overlap regions has plural welded portions at which the plural separator sheets are welded. The plural welded portions are discretely formed along the first direction.

### CROSS-REFERENCE TO RELATED APPLICATION

This application claims priority under 35 USC 119 from Japanese Patent Application No. 2023-187954, filed on Nov. 1, 2023, the entire disclosure of which is incorporated by reference herein.

### BACKGROUND

### Technical Field

The present disclosure relates to a battery and a module.

### Related Art

Japanese Patent Application Laid-open (JP-A) No. 2021-22421, discloses a non-aqueous electrolyte secondary battery (hereinafter, also referred to as a “battery”). The battery is provided with a negative electrode, a positive electrode, and a separator. The negative electrode has a negative electrode active material layer on at least a portion of a current collector, and has folded portions which are alternately folded back. The positive electrode has a positive electrode active material layer on at least a portion of a current collector, and is inserted into the folded portions. The separator is interposed between the negative electrode and the positive electrode. The separator is arranged in a sheet-like form on both surfaces of the positive electrode. An adhesive portion, to which at least a portion of an outer peripheral portion of the separator is adhered, is provided. JP-A No. 2021-22421, specifically discloses a battery in which adhesive portions 900a, 900b, 900c, 900d are formed on all sides of an outer peripheral portion of a separator 900 as shown in FIG. 6. In FIG. 6, reference numeral 910 denotes a power generation element provided with a positive electrode, a negative electrode, and a separator. Reference numeral 911 denotes a negative electrode terminal extending from the power generation element 910. Reference numeral 912 denotes a positive electrode terminal extending from the power generation element 920.

In a case in which charging and discharging of the battery are repeated, gas may be generated owing to the progress of a decomposition reaction of the non-aqueous electrolyte. In the separator 900 disclosed in JP-A No. 2021-22421, adhesive portions 900a, 900b, 900c, 900d, are formed on all sides thereof. In other words, the separator 900 surrounds the entire positive electrode via the adhesive portions 900a, 900b, 900c, 900d. Therefore, gas is likely to accumulate between the separator and the positive electrode. In a case in which gas accumulates between the separator and the positive electrode, the battery reaction becomes less likely to proceed at the site where the gas accumulates, whereby lithium metal tends to precipitate on the surface of the positive electrode. In a case in which the lithium metal grows, a short circuit between the positive electrode and the negative electrode may occur.

### SUMMARY

The present disclosure provides a battery and a module that may suppress the occurrence of short circuiting.

A first aspect of the present disclosure is a battery including: a layer-type electrode body formed from a positive electrode sheet and a negative electrode sheet alternately layered in a layering direction with a separator sheet interposed therebetween; a laminate exterior body housing the electrode body; a first tab projecting from the laminate exterior body toward one side in a first direction orthogonal to the layering direction, the first tab being electrically connected to plural positive electrode sheets; and a second tab projecting from the laminate exterior body toward the one side or another side in the first direction, the second tab being electrically connected to plural negative electrode sheets, wherein, at respective edge regions in a second direction orthogonal to the layering direction and to the first direction, the electrode body has an overlap region at which only plural separator sheets overlap with each other, wherein at least one of the two overlap regions has a plurality of welded portions at which the plural separator sheets are welded, and wherein the plural welded portions are formed discretely along the first direction.

Here, “layer-type electrode body” refers to a battery in which each of a positive electrode sheet, a negative electrode sheet, and a separator sheet has a single-wafer shape, and the positive electrode sheet and the negative electrode sheet are alternately layered with separator sheet interposed there in between. Further, “laminate exterior body” refers to a case made of a laminate sheet. Further, “laminate sheet” refers to a sheet having at least a metal layer, a first resin layer layered on one main surface of the metal layer, and a second resin layer layered on the other main surface of the metal layer.

In the first aspect, the plural welded portions are discretely formed along the first direction. Therefore, the gas generated between the separator sheet and at least one of the positive electrode sheet or the negative electrode sheet (hereinafter, also referred to as the “positive/negative electrode sheets”) easily moves to the outside of the electrode body between adjacent welding portions of the overlap region of the separator sheet. This is more pronounced in a case in which the direction, in the second direction, of the side at which the welded portion is formed is upward. In other words, gas is less likely to accumulate between the separator sheet and the positive/negative electrode sheets than conventional configuration. As a result, lithium metal is less likely to precipitate on the surface of the positive/negative electrode sheets. Furthermore, the plural separator sheets are integrated by the plural welding portions, and the separator sheet is securely interposed between the positive electrode sheet and the negative electrode sheet. As a result, in the battery of the first aspect, the occurrence of short circuiting may be suppressed.

In a second aspect of the present disclosure, in the first aspect, lengths of the plural welded portions in the first direction may be identical.

As a result, gas generated between the separator sheet and the positive/negative electrode sheets is more likely to move outside of the electrode body, than in a configuration in which the lengths of the plural welded portions in the first direction are not the same. As a result, in the battery of the second aspect, the occurrence of short circuiting may be further suppressed.

In a third aspect of the present disclosure, in the above first or second aspect, gaps between adjacent welded portions among the plurality of welded portions in the first direction, may be identical.

As a result, gas generated between the separator sheet and the positive/negative electrode sheets is more likely to move outside of the electrode body, than in a configuration in which gaps between adjacent welded portions in the first direction are not the same. As a result, in the battery of the third aspect, the occurrence of short circuiting may be further suppressed.

In a fourth aspect of the present disclosure, in any one of the above first to third aspect, both of the two overlap regions may have a plurality of the welded portions formed discretely along the first direction.

As a result, gas generated between the separator sheet and the positive/negative electrode sheets tends to move outside the electrode body more easily than in a configuration in which one of the two overlap regions has a welded portion formed continuously along the first direction. As a result, in the battery of the fourth aspect, the occurrence of short circuiting may be further suppressed.

A fifth aspect of the present disclosure is a module, including: the battery of any one of the above first aspect to the fourth aspect; a case housing a plurality of the batteries, wherein a direction of a side at which the welded portions are formed, is upward in the second direction.

Here, “upward” refers to the opposite direction from the direction of gravity.

In general, the specific gravity of a gas, generated by a decomposition reaction of a non-aqueous electrolyte or the like, is smaller than the specific gravity of a non-aqueous electrolyte. In other words, the gas in a non-aqueous electrolyte tends to move upward. In the fifth aspect, the direction, in the second direction, of the side at which the welded portion is formed, is the upward direction. In other words, the battery is arranged so that the region on the side in which the weld portion is discretely formed along the first direction, among the two overlap regions of the plural separator sheets, is disposed upward. As a result, gas generated between the separator sheet and the positive/negative electrode sheets tends to move to the outside above the electrode body. As a result, in the module of the fifth aspect, the occurrence of short circuiting may be further suppressed.

According to the above aspects, the battery and the module of the present disclosure may suppress the occurrence of short circuiting.

### BRIEF DESCRIPTION OF THE DRAWINGS

Exemplary embodiments will be described in detail based on the following figures, wherein:

FIG. 1 is a perspective view of a module of an embodiment of the present disclosure;

FIG. 2 is a top view of the module according to the embodiment of the present disclosure in a state in which the case lid removed;

FIG. 3 is a front view of a battery according to an embodiment of the present disclosure;

FIG. 4 is a front view of an electrode body according to an embodiment of the present disclosure;

FIG. 5 is a cross-sectional view taken along line V-V of FIG. 4; and

FIG. 6 is a front view of a separator of a conventional battery.

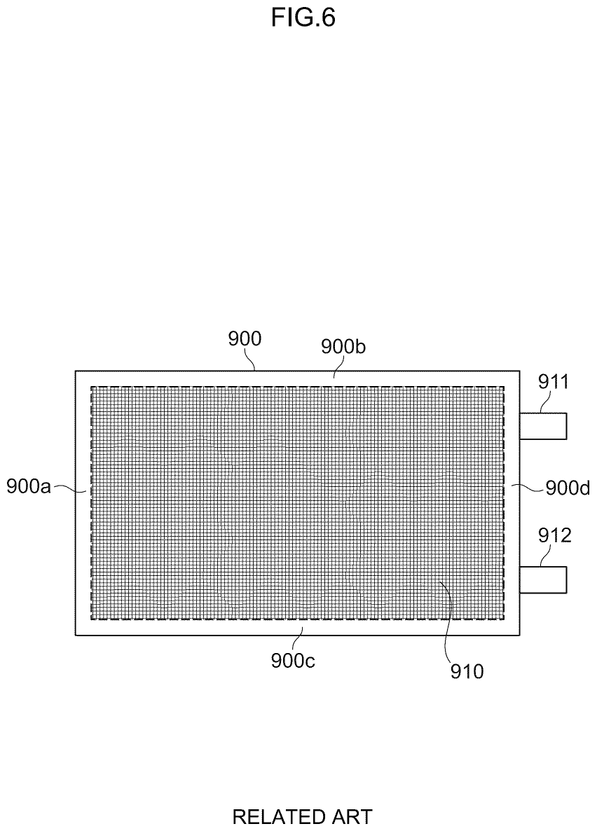

### DETAILED DESCRIPTION

Hereinafter, embodiments of the present disclosure will be described. These descriptions and examples illustrate embodiments and do not limit the scope of the embodiments. In the present disclosure, a combination of two or more preferred embodiments is a more preferred embodiment. In the present disclosure, a numerical range expressed using “to” means a range in which the numerical values described before and after “to” are included as the lower limit value and the upper limit value. In numerical ranges given in a stepwise manner in the present disclosure, the upper limit or lower limit given in one numerical range may be replaced with the upper limit or lower limit of another numerical range described in a stepwise manner. In the numerical ranges set forth in the present disclosure, the upper or lower limit of the numerical range may be replaced with a value set forth in the examples.

Hereinafter, embodiments of a battery and a module of the present disclosure will be described with reference to the drawings. In the drawings, the same or corresponding portions are denoted by the same reference numerals, and description thereof will not be repeated.

### (1) Module

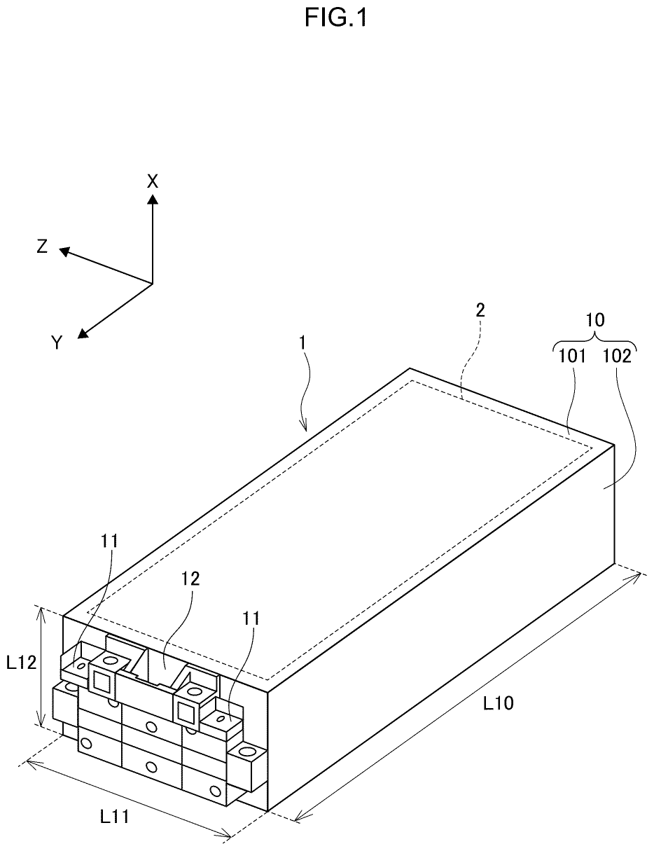

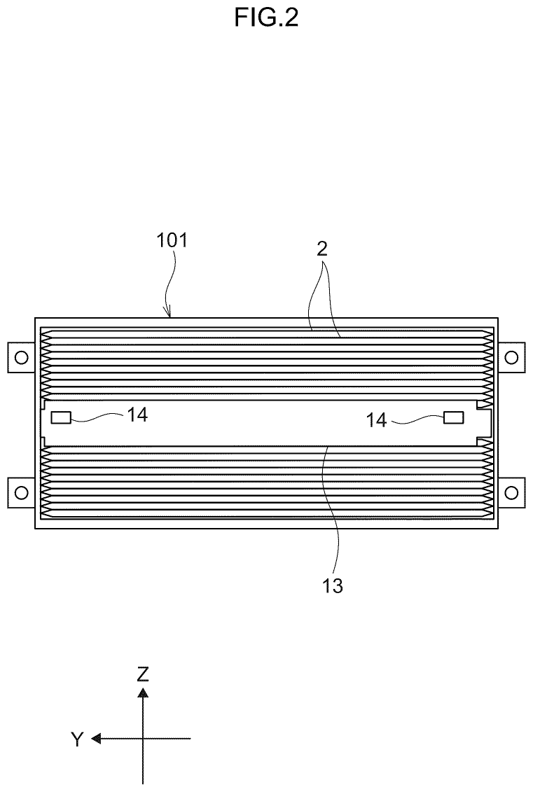

As shown in FIGS. 1 and 2, a module 1 according to an embodiment of the present disclosure is provided with plural batteries 2 and a case 10. The case 10 houses the plural batteries 2. The module 1 has a rectangular parallelepiped shape.

In the present embodiment, the thickness direction of the module 1 is defined as the X-axis direction, the longitudinal direction of the main surface of the module 1 is defined as the Y-axis direction, and the transverse direction of the module 1 is defined as the Z-axis direction. The X-axis, the Y-axis, and the Z-axis are respectively orthogonal to each other. The X-axis direction is an example of a second direction. The X-axis positive direction is an example of an upper direction. The Y-axis direction is an example of a first direction. The Z-axis direction is an example of a layering direction. Note that these orientations do not limit the orientation of the battery and the module of the present disclosure when used.

The length L10 of the module 1 in the Y-axis direction is, for example, 350 mm to 600 mm. The length L11 of the module 1 in the Z-axis direction is, for example, 150 mm to 250 mm. The length L12 of the module 1 in the X-axis direction is, for example, 80 mm to 110 mm.

A pair of voltage terminals 11 and a connector 12 are provided at both ends of the module 1 in the Y-axis direction, respectively. A flexible printed board 13, described later, is connected to the connector 12. A bus bar (not illustrated) is welded to both ends of the module 1 in the Y-axis direction.

The case 10 has a case body 101 and a case lid 102. The case 10 is formed of an aluminum alloy. The case 10 is formed, for example, by joining aluminum die-casting to both end portions of an extruded material of an aluminum alloy by laser welding or the like.

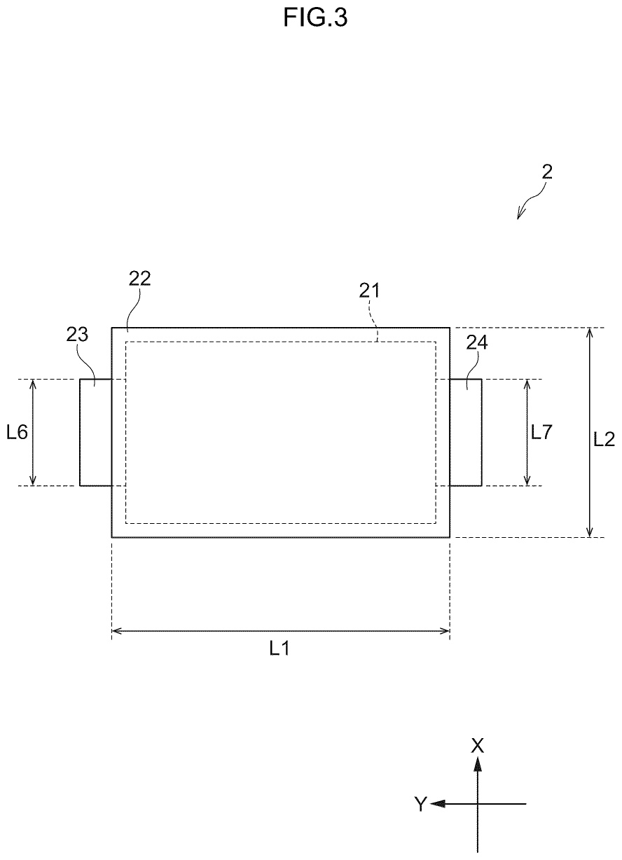

As shown in FIG. 2, plural batteries 2 are housed in an arrayed state inside the module 1. In the present embodiment, twenty-four batteries 2 are arrayed along the Z-axis direction. Adjacent batteries 2 are adhered to each other. The details of the battery 2 will be described later with reference to FIGS. 3 to 5.

A flexible printed circuit board (FPC: Flexible Printed Circuit) 13 is disposed on the battery 2. The flexible printed circuit board 13 is formed in a band shape with the X-axis direction as a longitudinal direction, and thermistors 14 are provided at both end portions of the flexible printed circuit board 13. In the module 1, the thermistor 14 is not adhered to the battery 2, and is pressed toward the battery 2 side by the case lid 102.

One or more cushioning materials (not illustrated) are housed inside the module 1. For example, the cushioning material is a thin plate-shaped member which is elastically deformable, and is arranged between adjacent batteries 2 with the arrangement direction of the batteries 2 as the thickness direction. In the present embodiment, as an example, cushioning materials are arranged at both ends in the longitudinal direction of the module 1 and at the central portion in the longitudinal direction, respectively.

### (2) Battery

As shown in FIG. 3, the battery 2 is provided with an electrode body 21, a laminate exterior body 22, a positive electrode tab 23, a negative electrode tab 24, and a non-aqueous electrolyte (not shown). The battery 2 has a rectangular parallelepiped shape.

The laminate exterior body 22 houses the electrode body 21 and the non-aqueous electrolyte. The positive electrode tab 23 protrudes from the laminate exterior body 22 in the Y-axis positive direction. The negative electrode tab 24 protrudes from the laminate exterior body 22 in the Y-axis negative direction.

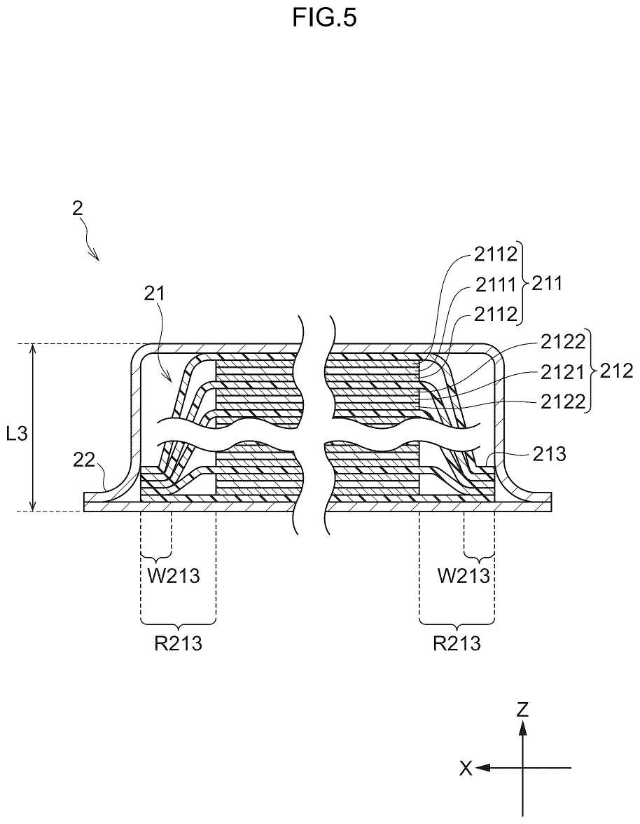

The length L1 of the battery 2 in the Y-axis direction (see FIG. 3) is, for example, 530 mm to 600 mm. The length L2 of the battery 2 in the X-axis direction (see FIG. 3) is, for example, 80 mm to 110 mm. The length L3 of the battery 2 in the Z-axis direction (see FIG. 5) is, for example, 7.0 mm to 9.0 mm.

### (2.1) Electrode Bodies

The structure of the electrode body 21 is a layered-type. As shown in FIG. 5, the electrode body 21 includes plural positive electrode sheets 211, plural negative electrode sheets 212, and plural separator sheets 213. In the electrode body 21, a positive electrode sheet 211 and a negative electrode sheet 212 are alternately layered along the Z-axis direction with a separator sheet 213 interposed therebetween.

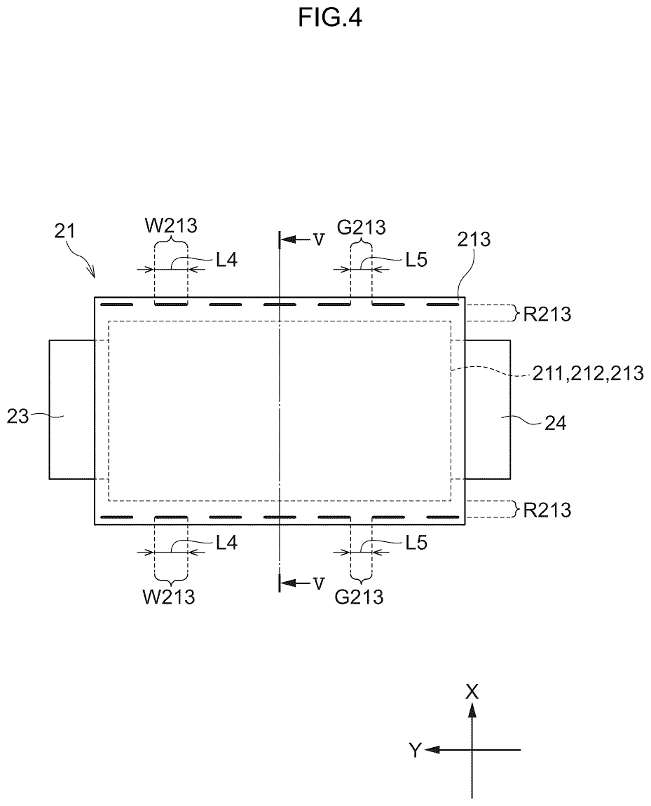

As shown in FIG. 4, the electrode body 21 has an overlap region R213 at both edge regions in the X-axis direction. In the overlap region R213, as shown in FIG. 5, only the plural separator sheets 213 overlap with each other. In the present embodiment, the two overlap regions R213 have plural welded portions W213. At the welded portion W213, plural separator sheets 213 are welded. The plural welded portions W213 are discretely formed along the Y-axis direction. In the present embodiment, the length L4 of each of the plural welded portions W213 in the Y-axis direction (see FIG. 4) is the same. Among the plural welded portions W213, the gap L5 (see FIG. 4) between adjacent welded portions W213 in the Y-axis direction is the same.

The respective numbers of the positive electrode sheet 211, the negative electrode sheet 212, and the separator sheet 213 are not particularly limited, and are appropriately selected in accordance with the use of the battery 2.

### (2.1.1) Positive Electrode Sheet

The positive electrode sheet 211 has a positive electrode current collector 2111 (for example, aluminum foil or the like), and a positive electrode active material layer 2112 supported on both surfaces of the positive electrode current collector 2111. The positive electrode active material layer 2112 contains a positive electrode active material. The positive electrode active material releases lithium ions into or occludes lithium ions from the non-aqueous electrolyte. The positive electrode active material may be a known positive electrode active material (for example, LiNiO₂ or LiNi_{1/3}Co_{1/3}Mn_{1/3}O₂). The positive electrode active material layer 2112 may further contain a known conductive material (for example, carbon black), trilithium phosphate, and a known binder (for example, polyvinylidene fluoride).

### (2.1.2) Negative Electrode Sheet

The negative electrode sheet 212 has a negative electrode current collector 2121 (for example, copper foil or the like) and a negative electrode active material layer 2122 supported on both surfaces of the negative electrode current collector 2121. The negative electrode active material layer 2122 contains a negative electrode active material. As the negative electrode active material charges and discharges, lithium ions, which are charge carriers, are occluded from the non-aqueous electrolyte and released into the non-aqueous electrolyte. The negative electrode active material may be any known negative electrode active material (artificial graphite or lithium-alloy (for example, LiXM, where M is C, Si, Sn, Sb, Al, Mg, Ti, Bi, Ge, Pb or P, and X is a natural number)). The negative electrode active material layer 2122 may further contain a known binder (for example, a styrene-butadiene copolymer).

### (2.1.3) Separator Sheet

The separator sheet 213 electrically insulates the positive electrode sheet 211 and the negative electrode sheet 212, and provides a lithium ion transfer path between the positive electrode active material layer 2112 and the negative electrode active material layer 2122. Examples of the separator sheet 213 include a porous film. Examples of the material of the porous film include polyethylene and polypropylene. The separator sheet 213 may have a single-layer structure or a multilayer structure.

### (2.2) Laminate Exterior Body

The laminate exterior body 22 covers the electrode body 21 and seals the electrode body 21 and the non-aqueous electrolyte together with the positive electrode tab 23 and the negative electrode tab 24. In the present embodiment, the laminate exterior body 22 has a single-cup structure (see FIG. 5). Here, “single-cup structure laminate exterior body” refers to a single laminate exterior body having a bending line, one cup portion (recessed portion) capable of housing the entire electrode body, and a flat portion, in which the flat portion covers the recessed portion as a result of bending along the bending line. The laminate exterior body 22 includes a laminate sheet.

### (2.2.1) Laminate Sheet

The laminate sheet has a metal layer, an inner resin layer, and an outer resin layer. The inner resin layer is layered on the surface of the metal layer at the side of the electrode body 21. The outer resin layer is layered on the surface of the metal layer at an opposite side from the electrode body 21. The metal layer blocks gas (for example, moisture or air) outside of the battery 2 and inside of the battery 2 from entering and leaving. The material of the metal layer is a metal (for example, aluminum). The inner resin layer electrically insulates the electrode body 21, the positive electrode tab 23, and the negative electrode tab 24 from the metal layer. The inner resin layer may contain a thermoplastic resin. The outer resin layer improves the durability of the laminate sheet. The outer resin layer may contain a thermoplastic resin. Examples of the thermoplastic resin of each of the inner resin layer and the outer resin layer include olefinic resins (for example, polypropylene, polyethylene, and the like), polyvinyl chloride, and polyvinylidene chloride.

### (2.3) Positive Electrode Tab

The positive electrode tab 23 is electrically connected to the plural positive electrode current collectors 2111. Examples of the material of the positive electrode tab 23 include a metal (for example, stainless steel (SUS)). The length L6 of the positive electrode tab 23 in the Y-axis direction (see FIG. 3) is, for example, 40 mm to 50 mm.

### (2.4) Negative Electrode Tab

The negative electrode tab 24 is electrically connected to the plural negative electrode current collectors 2121. Examples of the material of the negative electrode tab 24 include a metal (for example, stainless steel (SUS)). The length L7 of the negative electrode tab 24 in the Y-axis direction (see FIG. 3) is, for example, 40 mm to 50 mm.

### (2.5) Non-Aqueous Electrolyte

The battery 2 is provided with a non-aqueous electrolyte. The non-aqueous electrolyte is housed in the laminate exterior body 22 together with the electrode body 21. It is sufficient that the non-aqueous electrolyte be a solution in which a support salt as an electrolyte (for example, LiPF₆) is dissolved or dispersed in a non-aqueous solvent (for example, ethyl carbonate). The non-aqueous electrolyte may contain various additives (such as lithium bis(oxalato) borate).

### (3) Mechanism

As described with reference to FIGS. 1 to 5, the battery 2 is provided with the electrode body 21, the laminate exterior body 22, the positive electrode tab 23, and the negative electrode tab 24. The electrode body 21 has an overlap region R213. The overlap region R213 has plural welded portions W213. The plural welded portions W213 are discretely formed along the Y-axis direction. As a result, gas generated between the separator sheet 213 and at least one of the positive electrode sheet 211 or the negative electrode sheet 212 (hereinafter, referred to as “positive/negative electrode sheets 211, 212”) more easily moves to the outside of the electrode body 21 through the gaps G213 (see FIG. 4) between the adjacent welded portions of the overlap regions R213 of the separator sheets 213. In other words, gas is less likely to accumulate between the separator sheet 213 and the positive/negative electrode sheets 211, 212 than conventional configuration. As a result, lithium metal is less likely to precipitate on the surface of the positive/negative electrode sheets 211, 212. Furthermore, the plural separator sheets 213 are integrated by the plural welded portions W213, and the separator sheet 213 is securely interposed between the positive electrode sheet 211 and the negative electrode sheet 212. As a result, in the battery 2, the occurrence of short circuiting may be suppressed.

As described with reference to FIGS. 1 to 5, in the battery 2, the length L4 of each of the plural welded portions W213 in the Y-axis direction is the same (see FIG. 4). As a result, gas generated between the separator sheet 213 and the positive/negative electrode sheets 211, 212 easily moves outside the electrode body 21, as compared to a configuration in which the lengths of the plural welded portions W213 in the Y-axis direction are different. As a result, in the battery 2, the occurrence of short circuiting may be further suppressed.

As described with reference to FIGS. 1 to 5, in the battery 2, the gap L5 (see FIG. 4) between adjacent welded portions W213 in the Y-axis direction among the plural welded portions W213, is the same. As a result, gas generated between the separator sheet 213 and the positive/negative electrode sheets 211, 212 easily moves outside the electrode body 21, as compared to a configuration in which the distances of adjacent welded portions W213 in the Y-axis direction are different. As a result, in the battery 2, the occurrence of short circuiting may be further suppressed.

As described with reference to FIGS. 1 to 5, in the battery 2, both of the two overlap regions R213 have plural welded portions W213, discretely formed along the Y-axis direction. As a result, gas generated between the separator sheet 213 and the positive/negative electrode sheets 211, 212 easily moves outside the electrode body 21, as compared to a configuration in which one of the two overlap regions R213 has a welded portion W213 that is continuously formed along the Y-axis direction. As a result, in the battery 2, the occurrence of short circuiting may be further suppressed.

As described with reference to FIGS. 1 to 5, the module 1 is provided with plural batteries 2 and a case 10. The direction in the Y-axis direction of the side on which the welded portion W213 is formed, is upward.

In the module 1, the battery 2 is arranged so that one of the two overlap regions R213 of the plural separator sheets 213 is disposed upward. The gas generated in the battery 2 tends to move upward. Therefore, the gas generated between the separator sheet 213 and the positive/negative electrode sheets 211, 212 easily moves to the outside above the electrode body 21. As a result, in the module 1, the occurrence of short circuiting may be further suppressed.

### (4) Variant Example

In the present embodiment, a case in which the length L4 of each of the plural welded portions W213 in the Y-axis direction (see FIG. 4) is the same, has been described. However, the present disclosure is not limited thereto. In the present disclosure, the length L4 of each of the plural welded portions W213 in the Y-axis direction does not need to be the same.

In the present embodiment, a case in which the gap L5 (see FIG. 4) between adjacent welded portions W213 in the Y-axis direction among the plural welded portions W213 is the same, has been described. However, the present disclosure is not limited thereto. In the present disclosure, the gap L5 (see FIG. 4) between adjacent welded portions W213 in the Y-axis direction among the plural welded portions W213 does not need to be the same.

In the present embodiment, although both of the two overlap regions R213 have plural welded portions W213 discretely formed along the Y-axis direction, the present disclosure is not limited thereto. In the present disclosure, one of the two overlap regions R213 may have plural welded portions W213 discretely formed along the Y-axis direction.

In the present embodiment, a case in which the direction in the Y-axis direction of the side on which the welded portion W213 is formed is upward, has been described. However, the present disclosure is not limited thereto. In the present disclosure, the direction of the side on which the welded portion W213 is formed in the Y-axis direction does not need to be upward.

In the present embodiment, the laminate exterior body 22 has a single-cup structure (see FIG. 5), but the present disclosure is not limited thereto. In the present disclosure, the laminate exterior body 22 may have a double-cup configuration. Here, “double-cup structure” refers to a single laminate exterior body having a bending line, one first cup portion (recessed portion) capable of housing a portion of an electrode body, and one second cup portion (recessed portion) capable of housing a portion of an electrode body, which can accommodate the entire electrode body in a space formed by overlapping the first cup portion and the second cup with each other by bending along the bending line.

In the present embodiment, a case in which the positive electrode tab 23 protrudes from the laminate exterior body 22 in the Y-axis positive direction, and the negative electrode tab 24 protrudes from the laminate exterior body 22 in the Y-axis negative direction, has been described. However, the present disclosure is not limited thereto. In the present disclosure, the positive electrode tab 23 and the negative electrode tab 24 may protrude from the laminate exterior body 22 in the Y-axis positive direction or the Y-axis negative direction.

In the present embodiment, a case in which the use application of the battery 2 is a vehicle power supply, has been described. However, the present disclosure is not limited thereto. In the present disclosure, the use application of the battery 2 may be, for example, a power supply for an information processing apparatus (for example, a personal computer, a smartphone, or the like), a power supply for electricity storage, or the like.

What is claimed is:

1. A battery, comprising:
a layer-type electrode body formed from a positive electrode sheet and a negative electrode sheet alternately layered in a layering direction with a separator sheet interposed therebetween;
a laminate exterior body housing the electrode body;
a first tab projecting from the laminate exterior body toward one side in a first direction orthogonal to the layering direction, the first tab being electrically connected to a plurality of the positive electrode sheets; and
a second tab projecting from the laminate exterior body toward the one side or another side in the first direction, the second tab being electrically connected to a plurality of the negative electrode sheets,
wherein, at respective edge regions in a second direction orthogonal to the layering direction and to the first direction, the electrode body has an overlap region at which only a plurality of the separator sheets overlap with each other,
wherein at least one of the two overlap regions has a plurality of welded portions at which the plurality of separator sheets are welded, and
wherein the plurality of welded portions are formed discretely along the first direction.

2. The battery of claim 1, wherein lengths of the plurality of welded portions in the first direction are identical.

3. The battery of claim 2, wherein gaps between adjacent welded portions among the plurality of welded portions in the first direction, are identical.

4. The battery of claim 1, wherein both of the two overlap regions have a plurality of the welded portions formed discretely along the first direction.

5. A module, comprising:
the battery of claim 1; and
a case housing a plurality of the batteries,
wherein a direction of a side at which the welded portions are formed, is upward in the second direction.
